(19) United States
(12) Patent Application Publication
(10) Pub. No.: US 2023/0288863 A1
(43) Pub. Date: Sep. 14, 2023

(54) IMAGE FORMING APPARATUS AND DETERMINATION METHOD

(71) Applicant: KYOCERA Document Solutions Inc., Osaka-shi (JP)

(72) Inventors: Masashi FUJISHIMA, Osaka-shi (JP); Norio KUBO, Osaka-shi (JP); Koji SUENAMI, Osaka-shi (JP)

(21) Appl. No.: 18/117,572

(22) Filed: Mar. 6, 2023

(30) Foreign Application Priority Data
Mar. 10, 2022 (JP) 2022-036975

(51) Int. Cl. G03G 15/00

(52) U.S. Cl. CPC G03G 15/757; G03G 15/556; G03G 2215/00037

(57) ABSTRACT

An image forming apparatus includes: a gear provided on a transmission path of driving force from a drive unit to a photoreceptive drum; a first acquisition processor to acquire a charged amount of toner; a formation processor to form a toner image for detection based on an image for detection with density according to the charged amount of toner acquired by the first acquisition processor among a plurality of images for detection having different color from each other for every time when a specific formation timing arrives; a second acquisition processor to acquire a variation width of density in the toner image for detection formed by the formation processor; and a determination processor to determine a failure timing of the gear based on the variation width for each formation timing corresponding to any one of the plurality of images for detection.

### INCORPORATION BY REFERENCE

This application is based upon, and claims the benefit of priority from, corresponding Japanese Patent Application No. 2022-036975 filed in the Japan Patent Office on Mar. 10, 2022, the entire contents of which are incorporated herein by reference.

### BACKGROUND

### Field of the Invention

The present disclosure relates to an electrophotographic-type image forming apparatus and a determination method.

### Description of Related Art

In the electrophotographic-type image forming apparatus, a rotating member such as a photoreceptive drum used to form a toner image is rotatively driven by rotary driving force supplied by a drive unit such as a motor. In this sort of image forming apparatus, gears used to supply rotational drive power to the rotating member may fail due to aged deterioration. To address the issue, an image forming apparatus, which can determine a timing of gear failure based on drive current supplied to the drive unit, is conventionally known.

### SUMMARY

According to one aspect of the present disclosure, provided is an image forming apparatus including a gear, a first acquisition processor, a formation processor, a second acquisition processor, and a determination processor. The gear is provided on a transmission path of driving force from a drive unit to a rotating member used for forming a toner image. The first acquisition processor acquires a charged amount of toner used for forming the toner image. The formation processor forms a toner image for detection based on an image for detection with density according to the charged amount of toner acquired by the first acquisition processor among a plurality of images for detection having different color from each other for every time when a specific formation timing arrives using the rotating member. The second acquisition processor acquires a variation width of density in the toner image for detection formed by the formation processor The determination processor determines a failure timing of the gear based on the variation width for each formation timing corresponding to any one of the plurality of images for detection.

According to another aspect of the present disclosure, provided is a determination method executed in an image forming apparatus including a gear provided on a transmission path of driving force from a drive unit to a rotating member used for forming a toner image, which includes a first acquisition step, a formation step, a second acquisition step, and a determination step. In the first acquisition step, a charged amount of toner used for forming the toner image is acquired. In the formation step, a toner image for detection is formed based on an image for detection with density according to the charged amount of toner acquired by the first acquisition step among a plurality of images for detection having different color from each other for every time when a specific formation timing arrives using the rotating member. In the second acquisition step, a variation width of density in the toner image for detection formed by the formation step is acquired. In the determination step, a failure timing of the gear is determined based on the variation width for each formation timing corresponding to any one of the plurality of images for detection.

### BRIEF DESCRIPTION OF THE DRAWINGS

FIG. 1 is a cross sectional view illustrating a configuration of an image forming apparatus according to an embodiment of the present disclosure,

FIG. 2 is a block diagram illustrating a system configuration of the image forming apparatus according to the embodiment of the present disclosure,

FIG. 3 is a cross sectional view illustrating a configuration of the image forming unit of the image forming apparatus according to the embodiment of the present disclosure,

FIG. 4 is a diagram illustrating a configuration of a drive unit and driving force transmission section of the image forming apparatus according to the embodiment of the present disclosure,

FIG. 5 is a diagram illustrating a toner image for detection formed by the image forming apparatus according to the embodiment of the present disclosure,

FIG. 6 is a diagram showing an example of a detection result of density of the toner image for detection formed by the image forming apparatus according to the embodiment of the present disclosure,

FIG. 7 is a diagram showing an example of a change with time of a variation width of density of a toner image for detection acquired by the image forming apparatus according to the embodiment of the present disclosure,

FIG. 8 is a flowchart showing an example of a failure timing determination process performed in the image forming apparatus according to the embodiment of the present disclosure, and

FIG. 9 is a diagram showing an example of a change with time of a variation width of density of a toner image for detection acquired by the image forming apparatus according to the embodiment of the present disclosure.

### DETAILED DESCRIPTION

Now, an embodiment of the present disclosure will be described below with reference to the drawings. It should be noted that the following embodiment is a mere example to carry out the present disclosure and does not intend to limit the technical scope of the present disclosure.

Configuration of Image Forming Apparatus 100

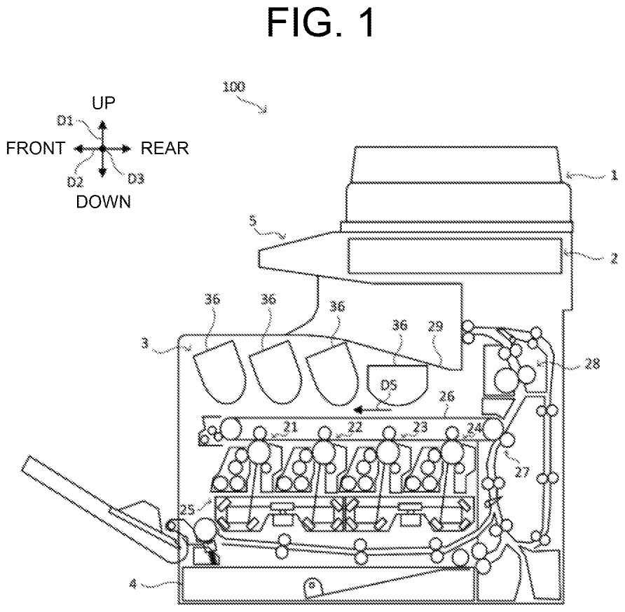

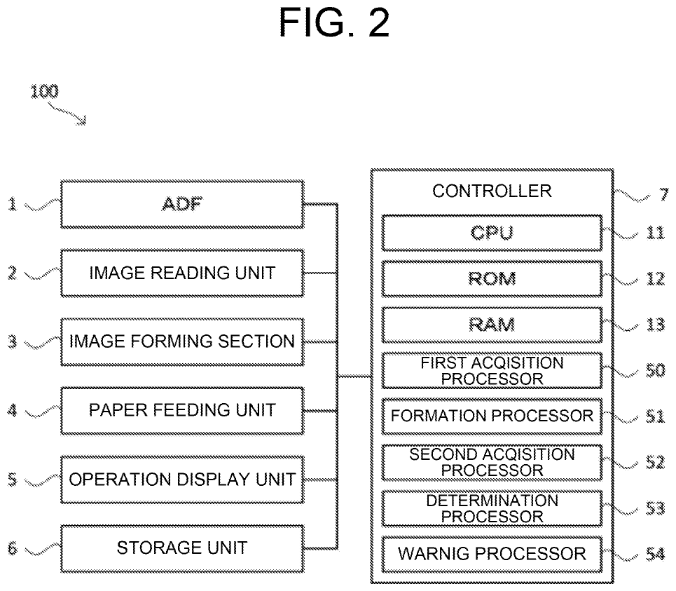

First, described with reference to FIGS. 1 and 2 is a configuration of an image forming apparatus 100 according to the embodiment of the present disclosure.

For convenience of explanation, in the state where the image forming apparatus 100 is ready to operate (state as shown in FIG. 1), a vertical direction is defined as an up-down direction D1. In addition, as viewed from the paper, a leftward of the image forming apparatus 100 shown in FIG. 1 is defined as a front side (front face), so that a front-rear direction D2 is defined. In addition, as viewed from the front side of the image forming apparatus 100 ready to operate, a left-right direction D3 is defined.

The image forming apparatus 100 is an image processing apparatus having a printing function for forming an image based on image data. Specifically, the image forming apparatus 100 is a multifunctional machine with multiple functions including the printing function. The image forming apparatus of the present disclosure may be a printer, fax machine, or copier capable of forming images by electrophotographic method.

As shown in FIGS. 1 and 2, the image forming apparatus 100 is equipped with an ADF (Auto Document Feeder) 1, an image reading unit 2, an image forming section 3, a paper feeding unit 4, an operation display unit 5, a storage unit 6, and a controller 7.

The ADF1 feeds a document on which an image to be read out by the image reading unit 2 is drawn. The ADF 1 includes a document placement portion, a plurality of conveying rollers, a document holder, and a paper discharge portion.

The image reading unit 2 realizes a scanning function to read out the image of the document. The image reading unit 2 includes a document table, a light source, plural mirrors, an optical lens, and a CCD (Charge Coupled Device).

The image forming section 3 realizes the printing function. Specifically, the image forming section 3 forms color or monochrome images on a sheet supplied from the paper feeding unit 4 according to the electrophotographic method.

The paper feeding unit 4 supplies a sheet to the image forming section 3. The paper feeding unit 4 is equipped with a sheet cassette, a manual feed tray, and a plurality of conveying rollers.

The operation display unit 5 is a user interface of the image forming apparatus 100. The operation display unit 5 is equipped with a display and a manipulator. The display unit displays various types of information in response to control instructions from the controller 7. For example, the display is a liquid crystal display. The user can input various information to the controller 7 through the manipulator responding to user operations. The manipulator is a touch panel, for example.

The storage unit 6 is a nonvolatile storage device. For example, the storage unit 6 is a nonvolatile memory such as a flash memory.

The controller 7 comprehensively controls the image forming apparatus 100. As shown in FIG. 2, the controller 7 has a CPU 11, a ROM 12, and a RAM 13. The CPU 11 is a processor to execute various types of arithmetic processing. The ROM 12 is a nonvolatile storage device in which information such as control program to cause the CPU 11 to execute the various types of processing is preliminarily stored in advance. The RAM 13 is a volatile or nonvolatile storage device used as a temporary storage memory (working area) for the various types of processing executed by the CPU 11. CPU 11 comprehensively controls the image forming apparatus 100 by executing various types of control program stored in advance in ROM 12.

The controller 7 may be a control unit separate from the main control unit which comprehensively controls the image forming apparatus 100. Furthermore, the controller 7 may be an electronic circuit such as an application-specific integrated circuit (ASIC).

Configuration of Image Forming Section 3

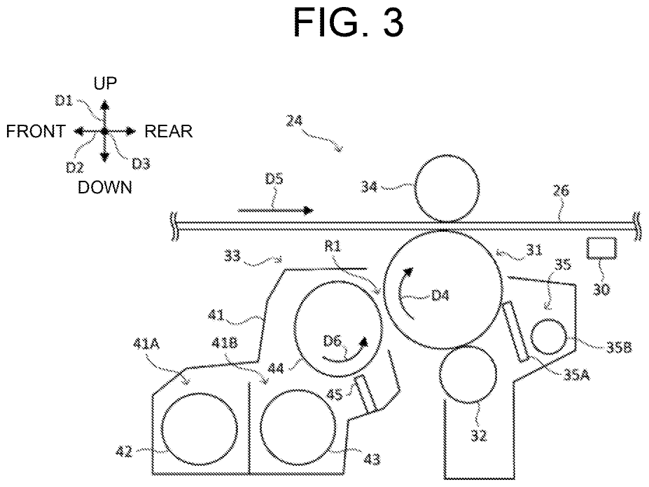

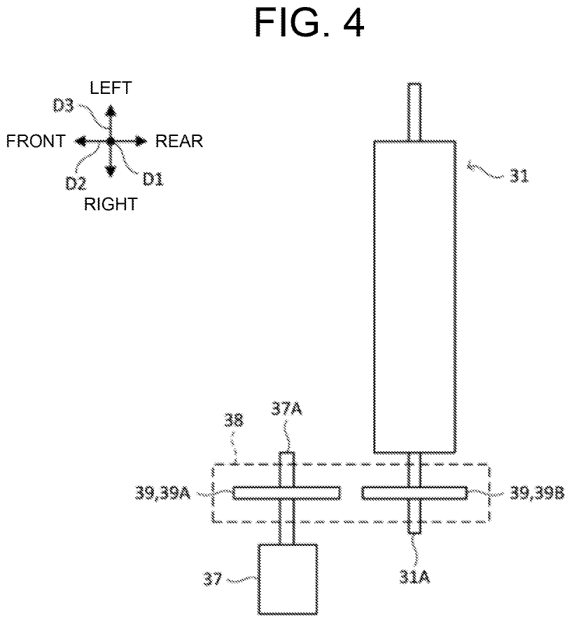

Next, a configuration of the image forming section 3 is described below with reference to FIGS. 1, 3, and 4. Here, FIG. 3 is a cross sectional view illustrating a configuration of the image forming unit 24. FIG. 4 is a diagram illustrating a photoreceptive drum 31, a drive unit 37, and driving force transmission section 38 as viewed from above.

As shown in FIG. 1, the image forming section 3 is equipped with a plurality of image forming units 21-24, an optical scanning device 25, an intermediate transfer belt 26, a secondary transfer roller 27, a fixing device 28, and a paper discharge tray 29. The image forming section 3 is also equipped with a plurality of density sensors 30 (see FIG. 3).

The image forming unit 21 forms a Y (yellow) color toner image. The image forming unit 22 forms a C (cyan) color toner image. The image forming unit 23 forms a M (magenta) color toner image. The image forming unit 24 forms a K (black) color toner image. As shown in FIG. 1, the image forming units 21-24 are arranged in the order of yellow, cyan, magenta, and black from the front side of the image forming apparatus 100 along the front-rear direction D2 of the image forming apparatus 100.

As shown in FIG. 3, the image forming unit 24 is equipped with the photoreceptive drum 31, a charging roller 32, a developing apparatus 33, a primary transfer roller 34, and a drum cleaning section 35. The image forming unit 24 is also equipped with a toner container 36 (see FIG. 1), a drive unit 37 (see FIG. 4), and a driving force transmission section 38 (see FIG. 4). Each of the image forming units 21-23 has the same configuration as the image forming unit 24.

An electrostatic latent image is formed on a surface of the photoreceptive drum 31. For example, the photoreceptive drum 31 has a photosensitive layer formed by an organic photosensitive material. The photoreceptive drum 31 is rotatably supported by a housing of the image forming apparatus 100, which houses the image forming section 3 and the paper feeding unit 4. The photoreceptive drum 31 receives rotary driving force transmitted from the drive unit 37, and rotates in a rotation direction D4 shown in FIG. 3. This allows the photoreceptive drum 31 to transfer the electrostatic latent image formed on a surface of the same. The photosensitive layer may be formed by other photosensitive materials such as amorphous silicon.

The photoreceptive drum 31 is used to form a toner image. The photoreceptive drum 31 is an example of an image carrier of the present disclosure as well as an example of a rotating member of the present disclosure.

The charging roller 32, to which a specific charging voltage is applied, electrically charges the surface of the photoreceptive drum 31. For example, the charging roller 32 electrically charges the surface of the photoreceptive drum 31 with positive polarity. As shown in FIG. 3, the charging roller 32 is provided in contact with the photoreceptive drum 31. The charging roller 32 is rotated by rotation of the photoreceptive drum 31. The surface of the photoreceptive drum 31 charged by the charging roller 32 is irradiated with light based on image data emitted from the optical scanning device 25. This allows an electrostatic latent image to be formed on the surface of the photoreceptive drum 31.

The developing apparatus 33 develops the electrostatic latent image formed on the surface of the photoreceptive drum 31 using developer including toner and carrier.

As shown in FIG. 3, the developing apparatus 33 has a housing 41, a first conveying member 42, a second conveying member 43, a developing roller 44, and a restrictor 45.

The housing 41 houses the first conveying member 42, the second conveying member 43, the developing roller 44, and the restrictor 45. The housing 41 also has a circulating-conveying path through which the developer circulates. The circulating-conveying path includes a first conveying path 41A (see FIG. 3) and a second conveying path 41B (see FIG. 3) extending along the left-right direction D3.

The first conveying member 42 transports the developer contained in the first conveying path 41A in one way of the left-right direction D3. The first conveying member 42 stirs the developer and frictionally charges the toner and carrier. For example, the toner is charged with positive polarity by being frictionally charged with the carrier. For example, the first conveying member 42 is a screw like member rotatable around a rotation axis of the first conveying member 42 along the left-right direction D3 in the first conveying path 41A.

The second conveying member 43 transports the developer contained in the second conveying path 41B in the other way opposite to the way conveyed by the first conveying member 42. The second conveying member 43 stirs the developer to frictionally charge the toner and carrier. For example, the second conveying member 43 is a screw like member rotatable around a rotation axis of the second conveying member 43 along the left-right direction D3 in the second conveying path 41B.

The developing roller 44 is provided to be opposed to the photoreceptive drum 31 and supplies the developer to a facing area R1 (see FIG. 3) which faces the photoreceptive drum 31. The developing roller 44 is used to form the toner image.

As shown in FIG. 3, the developing roller 44 is provided to be opposed to the second conveying member 43. The developing roller 44 pumps up the developer from the second conveying path 41B. The developer pumped up by the developing roller 44 forms a magnetic brush on the outer surface of the developing roller 44 with magnetic force from a magnet provided inside the developing roller 44. The developing roller 44 is rotatably supported by the housing 41 and rotates in the rotation direction D6 shown in FIG. 3 with rotary driving force from the motor (not shown). This allows the developing roller 44 to transfer the magnetic brush formed on the outer surface of the developing roller 44 to the facing area R1 (see FIG. 3). A specific development bias voltage is applied to the developing roller 44. This allows toner contained in the magnetic brush transferred to the facing area R1 to be supplied to the electrostatic latent image and to develop (visualize) the electrostatic latent image.

The restrictor 45 adjusts a thickness of layer of the magnetic brush formed on the outer surface of the developing roller 44. As shown in FIG. 3, the restrictor 45 is provided on the downstream side of the facing area sandwiched between the second conveying member 43 and the developing roller 44 in the rotation direction D6 and on the upstream side of the facing area R1 in the rotation direction D6. The restrictor 45 is provided to be opposed to the outer surface of the developing roller 44 so that a specific gap is formed between the restrictor 45 and the outer surface of the developing roller 44.

The developing apparatus 33 may be equipped with a magnetic roller which pumps up the developer from the second conveying path 41B and supplies the toner contained in the pumped up developer to the developing roller 44. In this example, the developing roller 44 may supply toner to the facing area R1. The developer may be a one-component developer without the carrier.

The primary transfer roller 34 transfers the toner image formed on the surface of the photoreceptive drum 31 by the developing apparatus 33 to the intermediate transfer belt 26 upon a specific primary transfer voltage is applied to the primary transfer roller 34. As shown in FIG. 3, the primary transfer roller 34 is provided in contact with a back surface of the intermediate transfer belt 26. The primary transfer roller 34 is provided to be opposed to the photoreceptive drum 31 across the intermediate transfer belt 26. The primary transfer roller 34 is rotated by rotation of the intermediate transfer belt 26.

The drum cleaning section 35 cleans the surface of photoreceptive drum 31. As shown in FIG. 3, the drum cleaning section 35 has a cleaning member 35A and a conveying member 35B. The cleaning member 35A removes deposits deposited on the surface of the photoreceptive drum 31. Specifically, the cleaning member 35A is a blade-like member provided in contact with the surface of the photoreceptive drum 31. The conveying member 35B conveys the deposits removed from the surface of the photoreceptive drum 31 by the cleaning member 35A to a container (not shown).

The toner container 36 contains toner. The toner container 36 supplies toner contained inside the same to developing apparatus 33.

The drive unit 37 generates driving force to rotate the photoreceptive drum 31. Specifically, the drive unit 37 is a motor which generates rotary driving force.

The driving force transmission section 38 transmits driving force generated by the drive unit 37 to the photoreceptive drum 31. The photoreceptive drum 31 is rotated by rotary driving force supplied from the drive unit 37 via the driving force transmission section 38.

As shown in FIG. 4, the driving force transmission section 38 has a plurality of gears 39 including a first gear 39A and a second gear 39B. The first gear 39A is fixed to a drive shaft 37A (see FIG. 4) of the drive unit 37 and thus rotates together with the drive shaft 37A. The second gear 39B is fixed to one end of a rotary shaft 31A (see FIG. 4) of the photoreceptive drum 31 in a direction aligned with the rotary shaft 31A (left-right direction D3) and thus rotates together with the rotary shaft 31A. Specifically, the second gear 39B is fixed at a right end of the rotary shaft 31A. Provided between the first gear 39A and the second gear 39B are one or more gears 39 (not shown) used to transmit rotary driving force from the first gear 39A to the second gear 39B. The gears 39 included in the driving force transmission section 38 are provided on the transmission path of driving force from the drive unit 37 to the photoreceptive drum 31.

The first gear 39A may mesh with the second gear 39B. The driving force transmission section 38 may also transmit driving force generated by the drive unit 37 to both the photoreceptive drum 31 and the developing roller 44 (another example of a rotating member of the present disclosure).

The optical scanning device 25 emits light based on image data toward the surface of the photoreceptive drum 31 in each of the image forming units 21-24.

The Intermediate transfer belt 26 is an endless belt to which the toner image formed on the surface of the photoreceptive drum 31 in each of the image forming units 21-24 is transferred. The intermediate transfer belt 26 is tensioned at a specific tension by a drive roller, a tension roller, and four primary transfer rollers 34. The intermediate transfer belt 26 rotates in the rotation direction D5 shown in FIGS. 1 and 3 as the drive roller rotates by rotary driving force supplied from a motor (not shown). This allows the intermediate transfer belt 26 to convey the toner image transferred from each of the photoreceptive drums 31 to a position for transferring the toner image on a sheet by the secondary transfer roller 27.

The secondary transfer roller 27 transfers the toner image transferred on the surface of the intermediate transfer belt 26 on the sheet supplied from the paper feeding unit 4 upon a specific secondary transfer voltage is applied to the secondary transfer roller 27. As shown in FIG. 1, the secondary transfer roller 27 is provided in contact with the outer surface of the intermediate transfer belt 26. The secondary transfer roller 27 is rotatably supported by the housing of the image forming apparatus 100. The secondary transfer roller 27 is rotated by rotation of the intermediate transfer belt 26. The secondary transfer roller 27 is supported by the housing of the image forming apparatus 100 so as to be movable between a contact position where the secondary transfer roller 27 contacts the intermediate transfer belt 26 and a separation position where the secondary transfer roller 27 is separated from the intermediate transfer belt 26. The secondary transfer roller 27 receives driving force supplied from a moving mechanism (not shown) and moves between the contact position and the separation position.

The fixing device 28 fixes the toner image transferred to the sheet by the secondary transfer roller 27 onto the sheet.

The sheet, on which the toner image is fixed by the fixing device 28, is discharged to the paper discharge tray 29.

A plurality of density sensors 30 detect density of the toner image transferred on the outer surface of the intermediate transfer belt 26. As shown in FIG. 3, the plurality of density sensors 30 are located on the downstream side of the image forming unit 24 in the rotation direction D5 of the intermediate transfer belt 26 and on the upstream side of the secondary transfer roller 27 in the rotation direction D5. The plurality of density sensors 30 are arranged in parallel along the left-right direction D3 which is a width direction of the intermediate transfer belt 26.

Each of the density sensors 30 is a so-called reflective type optical sensor, and is equipped with a light emitting unit to emit light toward the outer surface of the intermediate transfer belt 26 and a light receiving unit to receive light emitted from the light emitting unit and reflected on the outer surface of the intermediate transfer belt 26. An electrical signal according to the amount of light received at the light receiving unit is input to the controller 7 from each of the density sensors 30.

In the image forming apparatus 100, it is often the case that the gears 39 installed in the driving force transmission section 38 fail due to aged deterioration. To address the issue, an image forming apparatus, which can determine a failure timing of the gears 39 based on drive current supplied to the drive unit 37, is conventionally known.

Here, at the timing when increase of load due to aged deterioration of the gears 39 is reflected in the drive current, aged deterioration of the gears 39 may considerably progress. Therefore, in a conventional approach in which the failure timing is determined based on the drive current, preparations for maintenance may not be ready by the time when the failure timing is determined.

In contrast, the image forming apparatus 100 according to the embodiment of the present disclosure can determine the failure timing of the gears 39 earlier as described below.

Configuration of Controller 7

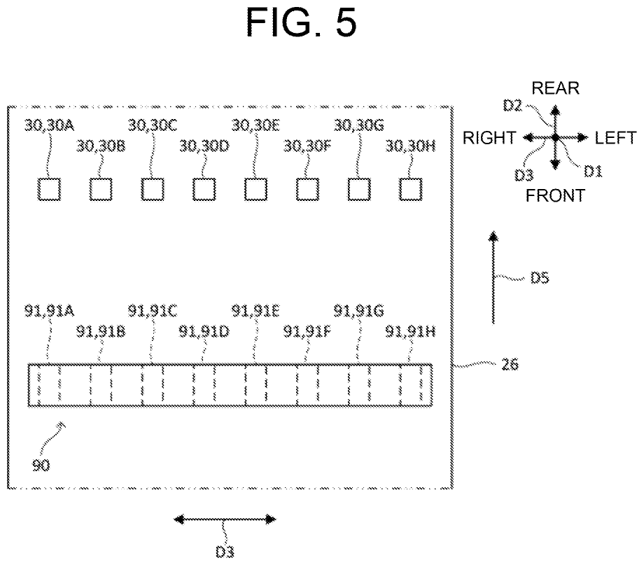

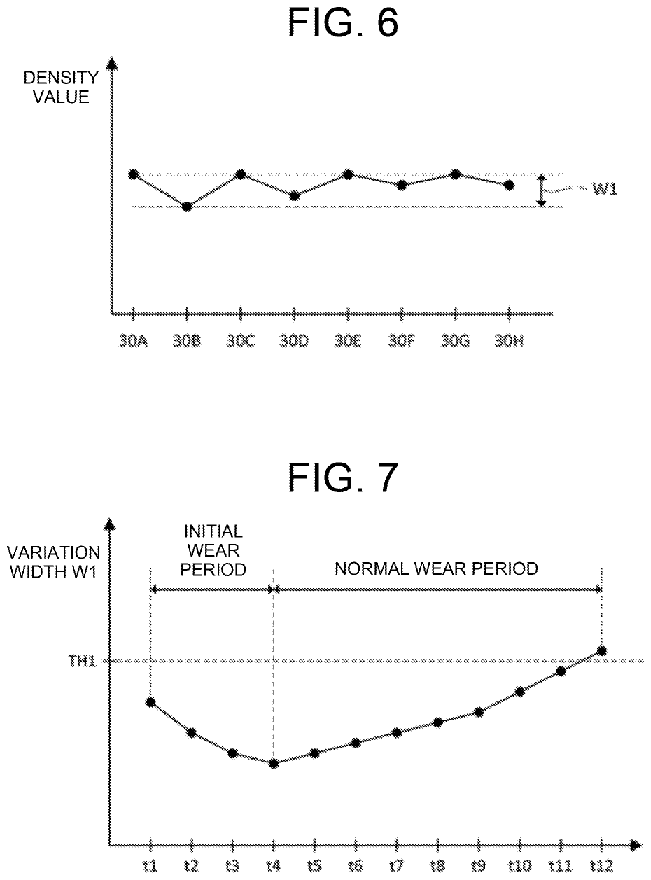

Next, the configuration of the controller 7 will be described with reference to FIGS. 2 through 7. Here, FIG. 5 is a diagram illustrating the outer surface of the intermediate transfer belt 26 viewed from an underside of the intermediate transfer belt 26, which shows a toner image for detection 90 and the plurality of density sensors 30 formed on the outer surface of the intermediate transfer belt 26. FIG. 6 shows an example of the density detection result of the toner image for detection 90 by the plurality of density sensors 30 (30A, 30B, 30C, 30D, 30E, 30F, 30G, and 30H). FIG. 7 also shows an example of a change with time of a variation width W1 obtained by the second acquisition processor 52.

As shown in FIG. 2, the controller 7 includes a first acquisition processor 50, a formation processor 51, a second acquisition processor 52, a determination processor 53, and a warning processor 54.

Specifically, the ROM 12 of the controller 7 stores a failure timing determination program to cause the CPU 11 to function as each of parts mentioned above. The CPU 11 functions as each of parts mentioned above by executing the failure timing determination program stored in the ROM 12.

The failure timing determination program is stored in a computer-readable storage medium such as CD, DVD, or flash memory, and may be read from the storage medium and then stored in a storage device such as the storage unit 6. In addition, a part or all of the first acquisition processor 50, formation processor 51, second acquisition processor 52, determination processor 53, and warning processor 54 may be composed of electronic circuits such as application-specific integrated circuit (ASIC).

In the following, exemplary explanations of parts included in and provided corresponding to the image forming unit 24 will be made on behalf of the image forming units 21-24. The following description can be similarly applied to each of the image forming units 21-23.

The first acquisition processor 50 acquires a charged amount of toner used for forming the toner image.

For example, the first acquisition processor 50 calculates the charged amount of toner based on the detection result of current flowing through the developing roller 44 at a timing when a specific electrostatic latent image is developed by the developing apparatus 33 and the density detection result of the toner image based on the specific electrostatic latent image. Specifically, when the formation timing described later arrives, the first acquisition processor 50 controls the image forming section 3 to form the toner image based on the specific electrostatic latent image on the photoreceptive drum 31. The first acquisition processor 50 uses an ammeter (not shown) to detect the current flowing through the developing roller 44 at the timing when the specific electrostatic latent image is developed. The first acquisition processor 50 detects density of the toner image based on the specific electrostatic latent image using the density sensor 30. The first acquisition processor 50 calculates the charged amount of toner by substituting in the specific equation the detection result of the current flowing through the developing roller 44 at the timing when the specific electrostatic latent image is developed and the density detection result of the toner image based on the specific electrostatic latent image. The first acquisition processor 50 may acquire the charged amount of toner at a timing different from the formation timing described below.

The first acquisition processor 50 may estimate the charged amount of toner based on an air temperature and humidity inside the housing of the image forming apparatus 100. Specifically, the first acquisition processor 50 may estimate the charged amount of toner using table data in which a combination of the air temperature and humidity is associated with an estimated value or estimated range of the charged amount of toner. The method of acquiring the charged amount of toner by the first acquisition processor 50 is not limited thereto, and other known method may be used.

For every time when a specific formation timing arrives, using the photoreceptive drum 31, the formation processor 51 forms the toner image for detection 90 (see FIG. 5) based on the image for detection of density corresponding to the charged amount of toner acquired by the first acquisition processor 50 among a plurality of images for detection with different density from each other.

Specifically, the formation timing is a timing when a cumulative total value of the number of printed sheets (number of printed sheets) output by the image forming apparatus 100 reaches a multiple of a specific reference number of sheets. The formation timing may be a timing when a cumulative total value of a driving time duration of the drive unit 37 reaches a multiple of a specific reference time.

Each of the images for detection is a monochromatic image expressed only by density of black which is a printing color corresponding to the image forming unit 24 among multiple printing colors (yellow, cyan, magenta, and black). For example, the plurality of images for detection include an image with 12 percent black density, an image with 25 percent black density, an image with 50 percent black density, and an image with 75 percent black density. Namely, each of the images for detection is a halftone image. The plurality of images for detection may include an image with 100 percent black density, i.e., a black image. The number of images for detection may be less than four or more than five.

As shown in FIG. 5, the toner image for detection 90 is an elongated toner image along the left-right direction D3 aligned with the rotary shaft 31A of the photoreceptive drum 31. Namely, the image for detection is an elongated image in the left-right direction D3. For example, the toner image for detection 90 consists of dots with a size (area) corresponding to density of the image for detection used to form the toner image for detection 90. The toner image for detection 90 may consist of dots with a specific size arranged by density corresponding to density of the image for detection used to form the toner image for detection 90.

For example, in the image forming apparatus 100, a plurality of image data for detection corresponding to the plurality of images for detection are stored in the ROM 12 of the controller 7 in advance.

For example, the formation processor 51 interrupts an image forming process when the formation timing arrives during execution of the image forming process to form an image based on image data.

The formation processor 51 selects one of the plurality of image data for detection as an image to be formed based on the charged amount of toner acquired by the first acquisition processor 50. For example, if the charged amount of the toner acquired by the first acquisition processor 50 is less than a specific first boundary value, the formation processor 51 selects as the image to be formed image data for detection corresponding to the image for detection with 12 percent black density. Furthermore, if the charged amount of toner acquired by the first acquisition processor 50 is not less than the first boundary value and less than a second boundary value which is higher than the first boundary value, the formation processor 51 selects as the image to be formed the image data for detection corresponding to the image for detection with 25 percent black density. Furthermore, if the charged amount of toner acquired by the first acquisition processor 50 is not less than the second boundary value and less than a third boundary value which is higher than the second boundary value, the formation processor 51 selects as the image to be formed the image data for detection corresponding to the image for detection with 50 percent black density. Furthermore, if the charged amount of toner acquired by the first acquisition processor 50 is not less than the third boundary value, the formation processor 51 selects as the image to be formed the image data for detection corresponding to the image for detection with 75 percent black density. Namely, in the image forming apparatus 100, the greater the charged amount of toner acquired by the first acquisition processor 50 is, the higher density of the image data for detection which is selected as the image to be formed is. The reason is that the higher the charged amount of toner is, the less likely toner in the facing area R1 is transferred to the photoreceptive drum 31, so that a density change due to the failure of the gears 39 less likely appears in the toner image for detection 90 with low density. The reason is also that the smaller the charged amount of toner is, the easier toner in the facing area R1 is transferred to the photoreceptive drum 31, so that the density change due to the failure of the gears 39 less likely appears in the toner image for detection 90 with high density. If the charged amount of toner is acquired at a timing different from the formation timing, the formation processor 51 may select as the image to be formed the image data for detection based on the charged amount of toner acquired last.

The formation processor 51 controls the image forming section 3 to form the toner image for detection 90 based on the image data for detection selected as the image to be formed. Specifically, the formation processor 51 drives each part of the image forming section 3 and the image data for detection as the image to be formed is thereby input to the optical scanning device 25, so that the toner image for detection 90 based on the image data for detection is formed onto the intermediate transfer belt 26. The formation processor 51 separates the secondary transfer roller 27 from the intermediate transfer belt 26 from a timing before the toner image for detection 90 reaches a facing position between the intermediate transfer belt 26 and the secondary transfer roller 27 to a timing after the toner image for detection 90 passes the facing position. Namely, the secondary transfer roller 27 is moved to the separation position.

The formation processor 51 may form the toner image for detection 90 without interrupting the image forming process when the formation timing arrives during executing the image forming process. Specifically, the formation processor 51 may form the toner image for detection 90 in a region of the intermediate transfer belt 26 where the intermediate transfer belt 26 does not contact the sheet supplied from the paper feeding unit 4 (paper absent region).

The second acquisition processor 52 acquires the variation width W1 of density (see FIG. 6) in the toner image for detection 90 formed by the formation processor 51.

Specifically, the second acquisition processor 52 acquires the variation width W1 based on a detection result of each of the density sensors 30.

Here, the toner image for detection 90 includes a plurality of detectees 91 (portions to be detected) (see FIG. 5) arranged along the left-right direction D3 which is the same as a longitudinal direction of the toner image for detection 90. In other words, a plurality of detectees 91 arranged along the left-right direction D3 are set in the toner image for detection 90 in advance. For example, the toner image for detection 90 includes eight detectees 91 (91A, 91B, 91C, 91D, 91E, 91F, 91G, and 91H) which are arranged with equally spaced apart from each other along the left-right direction D3. In FIG. 5, each of the detectees 91 is indicated by a dashed line.

As shown in FIG. 5, a plurality of density sensors 30 (30A, 30B, 30C, 30D, 30E, 30F, 30G, and 30H) are located at positions corresponding to the formation positions of the plurality of detectees 91 on the intermediate transfer belt 26 and detect densities of the plurality of detectees 91. Specifically, the density sensor 30A is located at a position corresponding to the formation position of the detectee 91A and detects density of the detectee 91A. The density sensor 30B is located at a position corresponding to the formation position of the detectee 91B and detects density of the detectee 91B. The density sensor 30C is located at a position corresponding to the formation position of the detectee 91C and detects density of the detectee 91C. The density sensor 30D is located at a position corresponding to the formation position of the detectee 91D and detects density of the detectee 91D. The density sensor 30E is located at a position corresponding to the formation position of the detectee 91E and detects density of the detectee 91E. The density sensor 30F is located at a position corresponding to the formation position of the detectee 91F and detects density of the detectee 91F. The density sensor 30G is located at a position corresponding to the formation position of the detectee 91G and detects density of the detectee 91G. The density sensor 30H is located at a position corresponding to the formation position of the detectee 91H and detects density of the detectee 91H.

For example, the second acquisition processor 52 acquires as the variation width W1 the difference between the highest value and the lowest value among a plurality of density values which corresponds to densities of the plurality of detectees 91 detected by the plurality of density sensors 30 (see FIG. 6).

Namely, the second acquisition processor 52 acquires the variation width W1 of density along the left-right direction D3 in the toner image for detection 90 formed by the formation processor 51.

For example, the second acquisition processor 52 stores in the storage unit 6 acquired data including the acquired variation width W1, density of the image for detection corresponding to the formed toner image for detection 90, and information indicating an acquisition date and time of the variation width W1.

As shown in FIG. 6, density of a region on the right side in the toner image for detection 90 more likely varies than that of a region on the left side in the toner image for detection 90. The reason is that vibration generated by the driving force transmission section 38 (see FIG. 4) provided on the right side of the photoreceptive drum 31 affects formation of the toner image. For example, if the right end side of the photoreceptive drum 31 vibrates due to vibration generated by the driving force transmission section 38, the distance between the photoreceptive drum 31 and the charging roller 32 changes. This causes a variation of the charged amount on the right end side of the photoreceptive drum 31, and thus causes a variation of toner density of the toner image for detection 90. When the right end side of the photoreceptive drum 31 vibrates due to the vibration generated by the driving force transmission section 38, the distance between the photoreceptive drum 31 and the developing roller 44 changes. This causes a variation of the amount of development on the right end side of the photoreceptive drum 31, and thus causes a variation of toner density of the toner image for detection 90.

The second acquisition processor 52 may acquire as the variation width W1 the difference between densities of the toner images for detection 90 at both ends of the toner images for detection 90 in the longitudinal direction of the toner image for detection 90. Namely, the second acquisition processor 52 may acquire as the variation width W1 the difference between the detection result by the density sensor 30A and the detection result by the density sensor 30H. In this example the plurality of density sensors 30 may consist of only two density sensors 30A and 30H.

Instead of the plurality of density sensors 30, a line sensor elongated in the left-right direction D3, which is capable of capturing the toner image transferred to the intermediate transfer belt 26, may be provided. In this example, the second acquisition processor 52 may acquire the variation width W1 using the line sensor. The plurality of density sensors 30 or the line sensor may be installed so as to be opposed to the sheet on which the toner image for detection 90 is transferred by the secondary transfer roller 27. The second acquisition processor 52 may also acquire the variation width W1 based on read image of the sheet on which the toner image for detection 90 is transferred by the image reading unit 2.

The determination processor 53 determines the failure timing of the gears 39 based on the variation width W1 for each of the formation timings corresponding to any one of the plurality of images for detection.

Specifically, the determination processor 53 determines the failure timing based on the variation width W1 for each of the formation timings corresponding to the image for detection in which the toner image for detection 90 is formed last among the plurality of images for detection.

The determination processor 53 determines the failure timing based on the variation width W1 for each of the formation timings on or after an end timing when a decrease trend of the variation width W1 ends among the variation widths W1 for each of the formation timings corresponding to the image for detection in which the toner image for detection 90 is formed last.

Here, it should be noted that the term “failure of the gears 39” in the specification indicates a state where the function of the gears 39 is deteriorated to such an extent that the image quality of the image formed using photoreceptive drum 31 is degraded in excess of a specific acceptable limitation. It should be also noted that the term “failure of the gear 39” in the specification includes a state, in addition to the state in which the function of the gears 39 is deteriorated, a state in which wear of the gears 39 progresses to such an extent that adverse effects mentioned above occur, and a state in which lubricant applied to the gears 39 is decreased to such an extent that the adverse effects mentioned above occur.

Specifically, in the image forming apparatus 100, if the variation width W1 acquired by the second acquisition processor 52 exceeds a specific threshold value TH1 (see FIG. 7), it is determined that the gear 39 is failed. The threshold value TH1 is defined for each of the images for detection. Specifically, the threshold value TH1 corresponding to the image for detection with 12 percent black density is a specific first value. The threshold value TH1 corresponding to the image for detection with 25 percent black density is a second value greater than the first value. The threshold value TH1 corresponding to the image for detection with 50 percent black density is a third value greater than the second value. The threshold value TH1 corresponding to the image for detection with 75 percent black density is a fourth value greater than the third value. Namely, the threshold value TH1 is defined so that the higher the density of the corresponding image for detection is, the greater the threshold value is.

FIG. 7 shows an example of change with time of the variation width W1 from a formation timing t1 to a formation timing t12 which are a plurality of consecutive formation timings corresponding to one of the images for detection. Here, the formation timing t1 is a formation timing when it arrives first after the image forming apparatus 100 is started. The formation timing t12 is a formation timing when it arrives first after the gear 39 is failed, i.e., after it is determined that the gear 39 is failed.

As shown in FIG. 7, the variation width W1 gradually decreases from the start of the image forming apparatus 100. The reason is that geometrical elements such as small burns in brand new gears 39, which causes the gears 39 to vibrate unnecessarily, are chipped away by driving of the gear 39. Here, it should be noted that a period of time, during which wear of the geometrical elements of the gear 39 progresses and the variation width W1 gradually decreases, is defined as the term “initial wear period” in the specification. In the example shown in FIG. 7, the initial wear period is from the formation timing t1 to the formation timing t4.

As shown in FIG. 7, the variation width W1 gradually increases from an end of the initial wear period. The reason is that gradual progress of wear of the gears 39 forces the function of the gear 39 to be degraded gradually. Here, it should be noted that a period of time, from the end of the initial wear period to a time after the variation width W1 starts gradually increasing until it is determined that the variation width W1 exceeds the threshold value TH1, is defined as the term “normal wear period” in the specification. In the example shown in FIG. 7, the normal wear period is from the formation timing t4 to the formation timing t12.

As shown in FIG. 7, the width of variation W1 during said normal wear period increases slightly curvedly. Therefore, it is possible to conduct a linear approximation on the change with time of the variation width W1 at the beginning of the normal wear period and to estimate the failure timing based on the approximation result. It is also possible to conduct a curve approximation on the change with time of the variation width W1 at the middle or up to the end of the normal wear period and to estimate the failure timing based on the approximation result.

For example, if the acquired data is stored in the storage unit 6 by the second acquisition processor 52, the determination processor 53 determines whether or not the end timing has already arrived, that is, whether or not the initial wear period elapses based on the acquired data and acquired data with the same density of the image for detection as the acquired data.

If the determination processor 53 determines that the end timing has already arrived, the determination processor 53 determines the failure timing based on the acquired data acquired on or after the end timing. For example, if the number of the acquired data acquired on or after the end timing is less than a specific reference number, the determination processor 53 conducts a linear approximation on change with time of the variation width W1 during the normal wear period and determines the failure timing based on the approximation result. If the number of the acquired data acquired on or after the end timing is not less than the reference number, the determination processor 53 conducts a curve approximation on change with time of the variation width W1 during the normal wear period and determines the failure timing based on the approximation result.

On the other hand, if the determination processor 53 determines that the end timing has not yet arrived, the determination processor 53 determines no failure timing.

The determination processor 53 may determine the failure timing based on the variation width W1 for each of formation timings before the end timing. For example, the determination processor 53 may determine the failure timing using artificial intelligence which has learned a relationship between change with time of the variation width W1 obtained during the initial wear period and change with time of the variation width W1 until the gear 39 fails. In this example, the artificial intelligence can learn the relationship by using as teacher data the data, which is obtained through experiments using a plurality of image forming apparatus 100, shows change with time of the variation width W1 from when the image forming apparatus 100 starts until the gear 39 fails for each of the image forming apparatus 100.

The determination processor 53 may also determine the failure timing based on the variation width W1 for each formation timing corresponding to the image for detection in which the number of formation of the toner image for detection 90 is the highest of the plurality of images for detection.

The warning processor 54 warns the failure timing determined by the determination processor 53.

For example, the warning processor 54 causes the operation display unit 5 to display a message including the failure timing determined by the determination processor 53. For example, the failure timing is indicated by the number of possible prints before the failure timing arrives or an operation time of the image forming section 3.

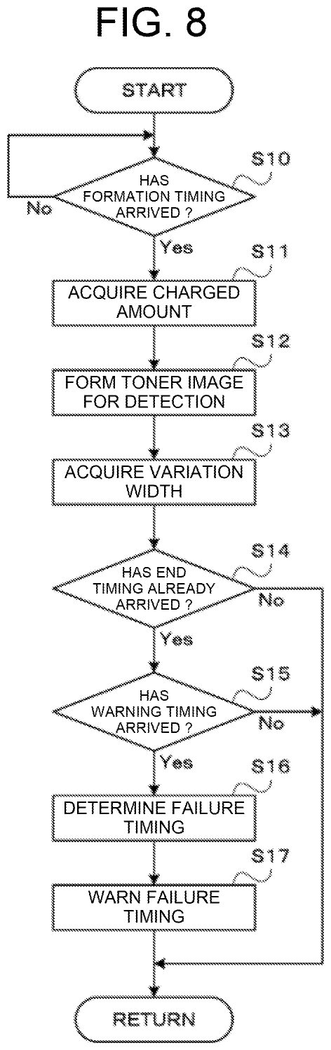

Failure Timing Determination Process Hereinafter, a determination method of the present disclosure is described below with reference to FIG. 8 using an example of a procedure of the failure timing determination process executed by the controller 7 in the image forming apparatus 100. Here, steps S11, S12, . . . denote step numbers assigned to process procedures (steps) executed by the controller 7. The failure timing determination process is executed together with the image forming process when the image forming process is executed.

Step S10

First, in step S10, the controller 7 determines whether or not the formation timing arrives.

Specifically, when the cumulative total value of the number of printed sheets reaches a multiple of the reference number of sheets during execution of the image forming process, the controller 7 determines that the formation timing arrives.

Here, if the controller 7 determines that the formation timing arrives (Yes in S10), the process moves to step S11. If the formation timing does not yet arrive (No in S10), the controller 7 waits for the arrival of the formation timing in step S10.

Step S11

In step S11, the controller 7 interrupts the image forming process to acquire the charged amount of toner. It should be noted that the process of acquiring the charged amount of toner is an example of the first acquisition step of the present disclosure, and it is performed by the first acquisition processor 50 of the controller 7.

The process of acquiring the charged amount of toner may be performed at a time when the image forming apparatus 100 is turned on, when an operation mode of the image forming apparatus 100 is shifted from a power saving mode to a normal mode, or when instructions to execute the image forming process is input. If the process of acquiring the charged amount of toner is executed before execution of the failure timing determination process, the process of acquiring the charged amount of toner in step S11 may be omitted.

Step S12

In step S12, the controller 7 forms the toner image for detection 90 based on the image for detection with density according to the charged amount of toner acquired in step S11 among the plurality of images for detection. It should be noted that the process in step S12 is an example of a forming step of the present disclosure and it is performed by the formation processor 51 of the controller 7.

Specifically, the controller 7 selects as the image to be formed one of the plurality of the image data for detection based on the charged amount of toner acquired in step S11. The controller 7 also controls the image forming section 3 to form the toner image for detection 90 based on the image data for detection selected as the image to be formed. The controller 7 moves the secondary transfer roller 27 to the separation position, from a timing before the toner image for detection 90 reaches the facing position between the intermediate transfer belt 26 and the secondary transfer roller 27 to a timing after the toner image for detection 90 passes the facing position. After the toner image for detection 90 passes the facing position, the controller 7 moves the secondary transfer roller 27 to the contact position to resume the image forming process.

Step S13

In step S13, the controller 7 acquires the variation width W1 of density in the toner image for detection 90 formed in step S12. It should be noted that the process in step S13 is an example of a second acquisition step of the present disclosure, and it is executed by the second acquisition processor 52 of the controller 7.

Specifically, the controller 7 acquires as the variation width W1 the difference between the highest value and the lowest value of the plurality of density values corresponding to densities of the plurality of detectees 91 included in the toner image for detection 90, which are detected by a plurality of density sensors 30. Then, the controller 7 stores in the storage unit 6 the acquired data including the acquired variation width W1, density of the image for detection corresponding to the formed toner image for detection 90, and information indicating the date and time of acquisition of the variation width W1.

Here, the toner image for detection 90 is formed based on the image for detection which is a halftone image. This makes it possible to acquire the variation width W1 larger than a variation width W1 in which the toner image for detection 90 is formed based on an image with 100 percent black density, i.e., a black image for detection.

Step S14

In step S14, the controller 7 determines whether or not the end timing has already arrived.

Specifically, the controller 7 determines whether or not the end timing has already arrived based on the acquired data stored in the storage unit 6 in step S13 and the acquired data with the same density of the image for detection as the acquired data stored.

If the controller 7 determines that the end timing has already arrived (Yes in S14), the process moves to step S15. If the controller 7 determines that the end timing has not yet arrived (No in S14), the process moves to step S10.

If the controller 7 determines that the end timing has already arrived (Yes in S14), the process may move to step S16. Namely, the process in step S15 may be omitted.

Step S15

In step S15, the controller 7 determines whether or not a specific warning timing arrives.

For example, the warning timing includes a timing when the number of acquired data acquired on or after the end timing becomes two among the plurality of acquired data with the same density of the image for detection. The warning timing includes a timing when the number of acquired data acquired on or after the end timing becomes the same as the reference number among the plurality of acquired data with the same of the image for detection.

Here, when the controller 7 determines that the warning timing arrives (Yes in S15), the process moves to step S16. If the controller 7 determines that the warning timing does not arrives (No in S15), the process moves to step S10.

Step S16

In step S16, the controller 7 determines the failure timing of the gear 39. It should be noted that the process of step S16 is an example of a determination step of the present disclosure, and it is executed by the determination processor 53 of the controller 7.

Specifically, if the number of the acquired data acquired on or after the end timing is two among the plurality of acquired data with the same density of the image for detection, the controller 7 conducts a linear approximation on change with time of the variation width W1 during the normal wear period and determines the failure timing based on the approximation result. This makes it possible to determine the failure timing earlier.

If the number of acquired data acquired on or after the end timing is the same as the reference number among the plurality of acquired data with the same density of the image for detection, the controller 7 conducts a curve approximation on change with time of the variation width W1 during the normal wear period and determines the failure timing based on the approximation result. This makes it possible to determine the failure timing with higher accuracy than when conducting the linear approximation on change with time of the variation width W1 during the normal wear period.

Step S17

In step S17, the controller 7 warns the failure timing determined in step S16. Here, the process in step S17 is executed by the warning processor 54 of the controller 7.

Specifically, the controller 7 causes the operation display unit 5 to display a message including the failure timing determined in step S16. This allows the user to prepare for maintenance until the failure timing is warned. For example, the user can prepare gears 39 for replacement and lubricant applied to the gears 39. The user can also make a reservation of a maintenance service by a service person from the manufacturer of the image forming apparatus 100 in advance.

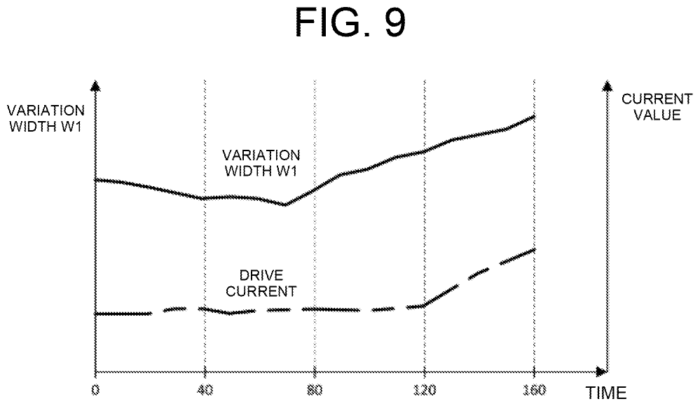

FIG. 9 shows an example of change with time of the variation width W1 and the drive current when a brand new image forming apparatus 100 is operated continuously until the gears 39 fail. In the example shown in FIG. 9, the gears 39 fail at the timing when the continuous use time of the image forming apparatus 100 reached 160 hours. In FIG. 9, change of time of the variation width W1 is illustrated by a thick solid line, and change of time of the drive current is illustrated by a thick one-dot chain line.

As shown in FIG. 9, the drive current gradually increases from around the timing when a continuous operating time of the image forming apparatus 100 reaches 120 hours to the failure timing of the gears 39. The reason is that increase of the load due to the aged deterioration of the gears 39 is reflected in the drive current.

On the other hand, as shown in FIG. 9, the variation width W1 gradually increases from around the timing when the continuous operating time of the image forming apparatus 100 reaches 70 hours to the failure timing of the gears 39. In short, increase in the variation width W1 commences earlier than that in the drive current. This allows the image forming apparatus 100 to determine the failure timing of the gears 39 earlier than a conventional apparatus configured to determine the failure timing based on the drive current.

Thus, in the image forming apparatus 100, the toner image for detection 90 is formed for every time when the formation timing arrives, and the variation width W1 of density in the formed toner image for detection 90 is acquired. The failure timing of the gears 39 is determined based on the variation width W1 for each of the formation timings. This makes it possible to determine the failure timing of the gears 39 earlier than the conventional apparatus configured to determine the failure timing based on the drive current.

Furthermore, in the image forming apparatus 100, the image for detection used for forming the toner image for detection 90 is changed according to the charged amount of toner. The failure timing of the gears 39 is then determined based on the variation width W1 for each of the formation timings corresponding to any one of the plurality of images for detection. Thereby, density of the toner image for detection 90 can be density in which the density change due to the failure of the gear 39 most likely appears at the timing when the toner image for detection 90 is formed. Therefore, it is possible to determine the failure timing more accurately than when only one image for detection is used for forming the toner image for detection 90.

What is claimed is:

1. An image forming apparatus comprising:
a gear provided on a transmission path of driving force from a drive unit to a rotating member used for forming a toner image;
a first acquisition processor to acquire a charged amount of toner used for forming the toner image;
a formation processor to form a toner image for detection based on an image for detection with density according to the charged amount of toner acquired by the first acquisition processor among a plurality of images for detection having different density from each other every time when a specific formation timing arrives using the rotating member;
a second acquisition processor to acquire a variation width of density in the toner image for detection formed by the formation processor; and
a determination processor to determine a failure timing of the gear based on the variation width for each formation timing corresponding to any one of the plurality of images for detection.

2. The image forming apparatus according to claim 1, wherein
the determination processor determines the failure timing based on the variation width for each formation timing corresponding to the image for detection in which the toner image for detection is formed last among the plurality of images for detection.

3. The image forming apparatus according to claim 1, wherein
the determination processor determines the failure timing based on the variation width for each formation timing on or after an end timing when a decrease trend of the variation width ends.

4. The image forming apparatus according to claim 1, wherein
the toner image for detection is elongated in a direction aligned with a rotary shaft of the rotating member,
the image forming apparatus includes a plurality of density sensors to detect densities of a plurality of detectees arranged along a longitudinal direction of the toner image for detection in the toner image for detection, and
the second acquisition processor acquires the variation width based on a detection result of each of the density sensors.

5. The image forming apparatus according to claim 1, wherein
the image for detection includes a halftone image.

6. The image forming apparatus according to claim 1, wherein
the rotating member includes an image carrier on which an electrostatic latent image is formed.

7. A determination method executed in an image forming apparatus including a gear provided on a transmission path of driving force from a drive unit to a rotating member used for forming a toner image, the method comprising:
first acquiring of acquiring a charged amount of toner used for forming the toner image;
forming a toner image for detection based on an image for detection with density according to the charged amount of toner acquired by the first acquiring among a plurality of images for detection having different density from each other every time when a specific formation timing arrives using the rotating member;
second acquiring of acquiring a variation width of density in the toner image for detection formed by the forming; and
determining a failure timing of the gear based on the variation width for each formation timing corresponding to any one of the plurality of images for detection.
